(19) United States
(12) Patent Application Publication
(10) Pub. No.: US 2024/0162760 A1
(43) Pub. Date: May 16, 2024

(54) ELECTRIC-POWER CONVERSION DEVICE, ELECTRICITY RECEIVING SYSTEM, AND METHOD FOR CONTROLLING THE SAME

(71) Applicant: Hitachi, Ltd., Tokyo (JP)

(72) Inventors: Makoto ITO, Tokyo (JP); Koichi WATANABE, Tokyo (JP); Tsukasa FUNANE, Tokyo (JP); Yosuke TANABE, Tokyo (JP); Hisatoshi KIMURA, Tokyo (JP); Keiji WATANABE, Tokyo (JP)

(21) Appl. No.: 18/507,319

(22) Filed: Nov. 13, 2023

(30) Foreign Application Priority Data
Nov. 16, 2022 (JP) 2022-183305

(51) Int. Cl. H02J 50/30; H02J 7/35; H02J 50/40

(52) U.S. Cl. CPC H02J 50/30; H02J 7/35; H02J 50/40

(57) ABSTRACT

An electric-power conversion device receives an electromagnetic wave transmitted from space and converts the electromagnetic wave into electric power. The electric-power conversion device includes: an electric-power conversion portion for receiving an electromagnetic wave transmitted from space and converting the electromagnetic wave into electric power; a propelling device or driving device for moving the electric-power conversion device; a positioning device for determining the position of the electric-power conversion device; a control device for controlling the propelling device or the driving device based on information about the position and the electric power received by the electric-power conversion portion; and an electric-power supply device for supplying the electric power received by the electric-power conversion portion to an electric system.

### CLAIM OF PRIORITY

The present application claims priority from Japanese Patent application serial No. 2022-183305 filed on Nov. 16, 2012, the content of which is hereby incorporated by reference into this application.

### BACKGROUND OF THE INVENTION

### 1. Field of the Invention

The present invention relates to electric-power conversion devices, electricity receiving systems, and methods for controlling the same in space solar power satellite/station/systems.

### 2. Description of the Related Art

As one of renewable energies, there have been proposed space solar power satellite/station/systems (SSPSs or SPSs) which convert solar light energy in space into electric energy through solar panels mounted on artificial satellites and the like, and transmit electric power to the ground through electromagnetic waves such as microwaves and laser light.

Such space solar power satellite/station/systems have been attracting attention, since they have advantages as follows. That is, such space solar power satellite/station/systems are not fluctuated due to weather and are capable of generating electric power day or night and, further, capable of using higher solar light density, as compared with solar power generation on the ground. For such space solar power satellite/station/systems, various technologies have been proposed for efficiently transmitting electric power generated in space to the ground.

For example, US2013/0032673 discloses a space solar power satellite/station/system including a space-based solar power satellite including a solar cell for converting solar energy into electric energy and a device for converting the electric energy into microwave energy, wherein the space-based solar power satellite directs microwave energy to the earth, and Rectennas installed on the ground receive the microwave energy and convert the microwave energy into electric power, thereby achieving transportation of the energy. Here, a Rectenna is a device including an antenna and a rectifier circuit, and adapted to extract DC electric power from electromagnetic waves such as microwaves.

### SUMMARY OF THE INVENTION

However, with the conventional space solar power satellite/station/system, the Rectennas cannot be easily moved and, therefore, during repair of failures of the Rectennas and maintenance of the Rectennas, for example, it is necessary to stop the electricity receiving system, which induces a problem of a decrease of the electricity receiving efficiency of the electricity receiving system in a product life cycle. In this regard, US2013/0032673 gives no consideration to the electricity receiving efficiency in a product life cycle.

In view of the aforementioned circumstances, it is an object of the present invention to provide an electric-power conversion device, an electricity receiving system, and a method for controlling the same which realize continuous and efficient reception of electricity, thereby improving the electricity receiving efficiency.

In view of the aforementioned circumstances, according to the present invention, there is provided “an electric-power conversion device for receiving an electromagnetic wave transmitted from space and converting the electromagnetic wave into electric power, the electric-power conversion device including: an electric-power conversion portion for receiving an electromagnetic wave transmitted from space and converting the electromagnetic wave into electric power; a propelling device or driving device for moving the electric-power conversion device; a positioning device for determining a position of the electric-power conversion device; a control device for controlling the propelling device or the driving device based on information about the position and electric power received by the electric-power conversion portion; and an electric-power supply device for supplying electric power received by the electric-power conversion portion to an electric system”.

Further, according to the present invention, there is provided “an electricity receiving system including a plurality of the electric-power conversion devices, wherein the plurality of the electric-power conversion devices are connected to an electric-power system through an electricity receiving station”.

Further, according to the present invention, there is provided “a method for controlling an electric-power conversion device for receiving an electromagnetic wave transmitted from space and converting the electromagnetic wave into electric power, the electric-power conversion device including: an electric-power conversion portion for receiving an electromagnetic wave transmitted from space and converting the electromagnetic wave into electric power; a propelling device or driving device for moving the electric-power conversion device; a positioning device for determining a position of the electric-power conversion device; a control device for controlling the propelling device or the driving device based on information about the position and electric power received by the electric-power conversion portion; and an electric-power supply device for supplying electric power received by the electric-power conversion portion to an electric system, wherein the control device analyzes information obtained from the electric-power conversion device and the positioning device and changes the position of the electric-power conversion device”.

Further, according to the present invention, there is provided “a method for controlling an electricity receiving system including a plurality of electric-power conversion devices for receiving an electromagnetic wave transmitted from space and converting the electromagnetic wave into electric power, the electric-power conversion devices being connected to an electric power system through an electricity receiving station, each electric-power conversion device including: an electric-power conversion portion for receiving an electromagnetic wave transmitted from space and converting the electromagnetic wave into electric power; a propelling device or driving device for moving the electric-power conversion device; a positioning device for determining a position of the electric-power conversion device; a control device for controlling the propelling device or the driving device based on information about the position and electric power received by the electric-power conversion portion; and an electric-power supply device for supplying electric power received by the electric-power conversion portion to an electric system, wherein the control device in each electric-power conversion device analyzes information obtained from the electric-power conversion device and the positioning device and changes the position of the electric-power conversion device”.

With the electricity receiving system according to the present invention, it is possible to provide an electric-power conversion device, an electricity receiving system, and a method for controlling the same, which are adapted to continuously and efficiently receive electromagnetic waves transmitted from space, using a plurality of movable electric-power conversion devices, thereby realizing improved electricity receiving efficiency.

### BRIEF DESCRIPTION OF THE DRAWINGS

FIG. 1 is a view illustrating an example of a schematic structure of an entire space solar power satellite/station/system;

FIG. 2 is a block diagram illustrating an example of a schematic structure of the entire space solar power satellite/station/system;

FIG. 3A is a view illustrating an example of an electromagnetic-wave energy intensity distribution forming a Gaussian distribution;

FIG. 3B is a view illustrating an example of an electromagnetic-wave energy intensity distribution which is a distribution having side lobes or grating lobes;

FIG. 4 is a block diagram illustrating an electricity receiving system in more detail;

FIG. 5 is a perspective view illustrating an example of a configuration of an electric-power conversion device;

FIG. 6 is a sequence diagram illustrating flows of information and electric power in the electricity receiving system;

FIG. 7 is a view illustrating a flowchart of operations of the electric-power conversion devices according to a first embodiment;

FIGS. 8A to 8D are views illustrating operations of the electric-power conversion devices according to the first embodiment;

FIG. 9 is a view illustrating a flowchart of operations of electric-power conversion devices according to a second embodiment;

FIGS. 10A and 10B are views illustrating operations of the electric-power conversion devices according to the second embodiment;

FIG. 11 is a view illustrating a flowchart of operations of electric-power conversion devices according to a third embodiment;

FIGS. 12A to 12B are views illustrating operations of the electric-power conversion devices according to the third embodiment;

FIG. 13 is a schematic view illustrating the structure of a space solar power satellite/station/system according to a fourth example; and

FIG. 14 is a block diagram illustrating the structure of the space solar power satellite/station/system according to the fourth example.

### DESCRIPTION OF THE PREFERRED EMBODIMENTS

Hereinafter, examples of the present invention will be described with reference to the drawings.

In the drawings, components having the same functions may be denoted by the same reference numerals. Note that, although the drawings illustrate embodiments and examples of implementations according to the principle of the present invention, these are merely for understanding of the present invention, and should never be used to restrictively interpret the present invention. The description in the present specification is merely illustrative and is not intended to limit the claims or applications of the present invention in any way.

Although the present examples are described in detail enough for those skilled in the art to implement the present invention, it should be understood that other implementations and aspects can be also adopted, and changes in configuration and structure and replacement of various components can be made thereto without departing from the scope and spirit of the technical concept of the present invention. Therefore, the following description should not be interpreted as being restrictive.

### First Example

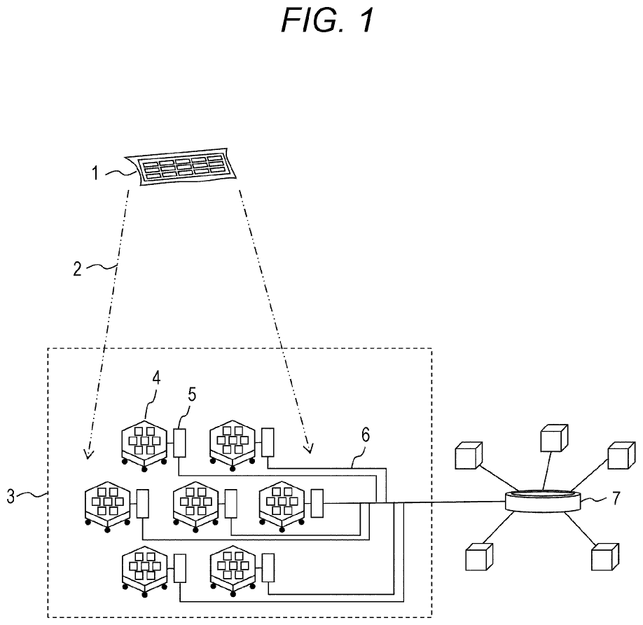

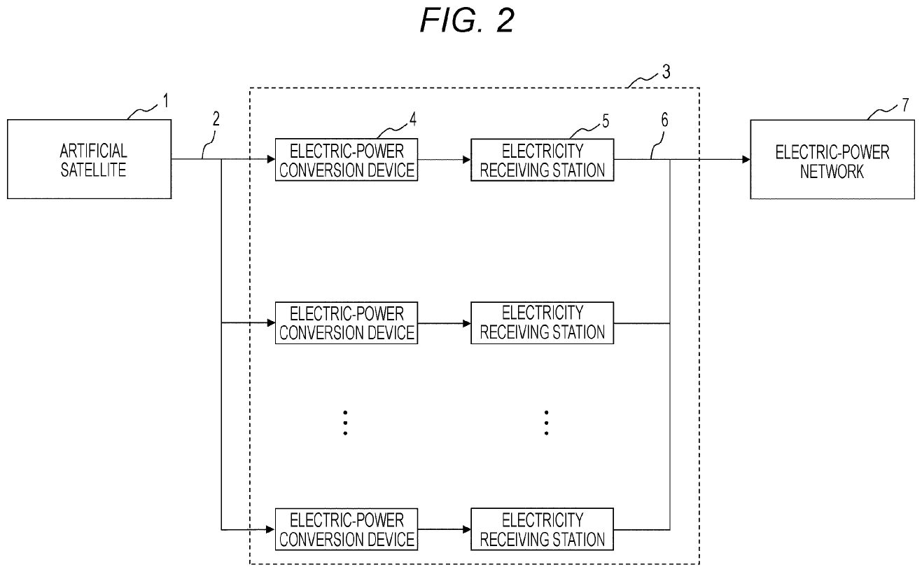

There will be described an example of a general structure of a space solar power satellite/station/system, with reference to FIGS. 1 and 2. FIG. 1 illustrates an example of the general structure of the entire space solar power satellite/station/system constituted by a space facility and a ground facility, and FIG. 2 is a block diagram of the space solar power satellite/station/system.

As illustrated in FIGS. 1 and 2, the space solar power satellite/station/system transmits an electromagnetic wave 2 such as a microwave or a laser light from an artificial satellite 1 which forms the space facility. On the other hand, the ground facility is structured to supply electric power to an electric-power network 7, through an electricity receiving system 3 constituted by a plurality of electric-power conversion devices 4 for receiving the electromagnetic wave 2 and converting it into electric power, electricity receiving stations 5 electrically connected to the electric-power conversion devices 4, and electric wires (or a wireless electric-power transmission system) 6. Incidentally, there is an one-to-one relationship between the electric-power conversion devices 4 and the electricity receiving stations 5, and the plurality of electric-power conversion devices 4 make a formation to receive the electromagnetic wave 2 transmitted from the artificial satellite 1.

As an example, the artificial satellite 1 is a geostationary satellite moving in a geostationary orbit (about 36000 km above the equator), and includes a solar panel (about 2.5 km×2.5 km, for example) for converting sunlight into electric power. The artificial satellite 1 is enabled to convert electric power from the solar panel into the microwave (electromagnetic wave) 2 having a frequency of 2.45 GHz (a wavelength of λ=12.2 cm), a frequency of 5.8 GHz (a wavelength of λ=5.17 cm), or a frequency of 10 GHz (a wavelength of λ=3.0 cm), for example. Further, the artificial satellite 1 is enabled to emit the microwave (electromagnetic wave) 2 from a transmission antenna toward the ground, with an energy pointing accuracy of about 1 urad, for example.

Although the artificial satellite 1 is not specifically illustrated, the artificial satellite 1 includes a frequency converting portion for converting DC electric power generated by the solar panel into AC electric power corresponding to the frequency of the electromagnetic wave, an electromagnetic-wave control portion for controlling the amplitude, the frequency and the phase of the electromagnetic wave, and the transmission antenna.

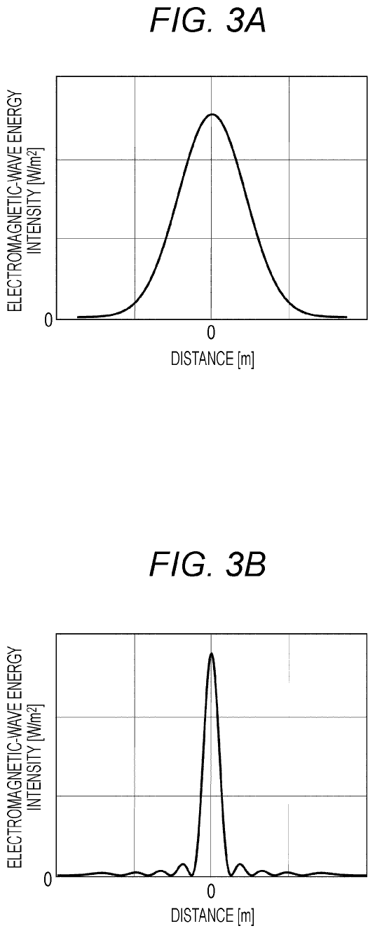

The electromagnetic wave transmitted from the artificial satellite 1 has a non-uniform energy intensity distribution, which may be a Gaussian distribution as illustrated in FIG. 3A in some cases and may be a distribution having a main distribution at its center portion and side lobes or grating lobes at its peripheries as illustrated in FIG. 3B in other cases. Even if the electromagnetic-wave energy intensity distribution forms the same Gaussian distribution, it may have a different distribution shape due to weather conditions and other conditions such as radio wave interference. The electricity receiving system receives electricity based on the electromagnetic-wave energy intensity distribution.

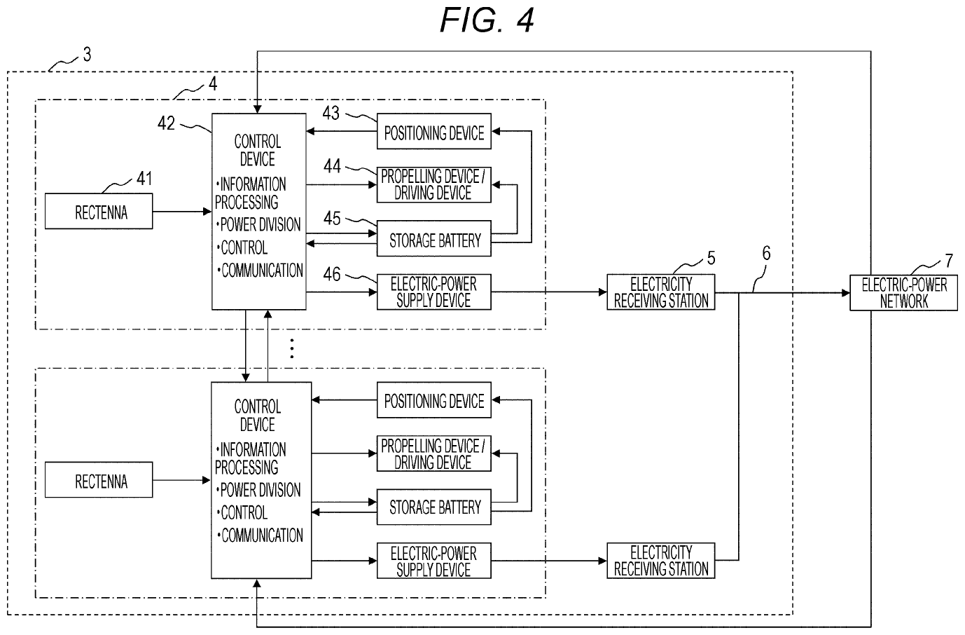

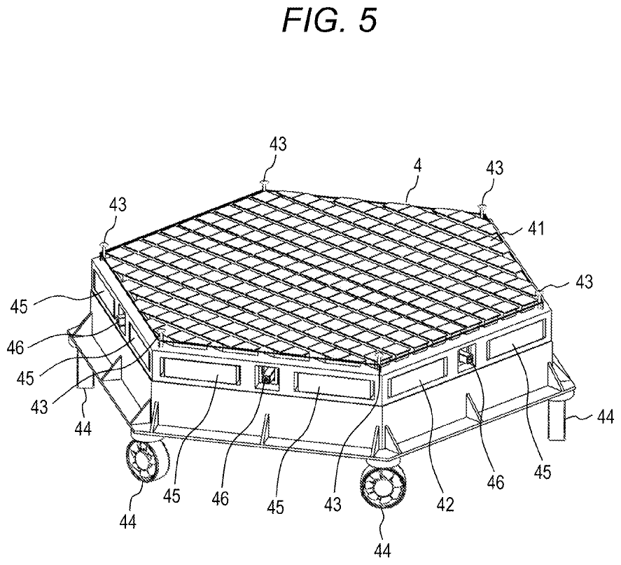

With reference to FIGS. 4 and 5, there will be described the structure of the electricity receiving system 3, and an example of the specific configuration of the electric-power conversion devices 4 which are main constituent components. FIG. 4 is a block diagram of the electricity receiving system 3, and FIG. 5 is a perspective view illustrating an example of the specific configuration of an electric-power conversion device 4.

As illustrated in FIG. 4, the electricity receiving system 3 is constituted by the plurality of electric-power conversion devices 4 (having a maximum size of about 50 m to 100 m, for example), the plurality of electricity receiving stations 5, and the electric wires (or the wireless electric-power transmission system) 6. The electricity receiving system 3 can electrically connect the electric-power conversion devices 4 and the electricity receiving stations 5 to each other and can supply received electric power to the electric-power network 7 through the electric wires (or the wireless electric-power transmission system) 6.

Further, as illustrated in FIG. 5, the electric-power conversion devices 4, which are main constituent components in the electricity receiving system 3, include Rectennas 41, a control device 42, positioning devices 43, propelling devices or driving devices 44, storage batteries 45, and electric-power supply devices 46. The electric-power conversion devices 4 can be assumed to be installed in various areas such as lands, seas, skies and spaces.

With this structure, the electric-power conversion devices 4 are enabled to move. On the other hand, the electricity receiving stations 5 can be either fixed or movable. However, in this case, it is assumed that the electricity receiving stations 5 are fixed, and the electric-power conversion devices 4 having moved thereto are connected to the electricity receiving stations 5 through couplers to supply and receive electric power thereto and therefrom.

Although not illustrated, the Rectennas 41 include a reception antenna and a rectifier circuit, and receive the electromagnetic wave and convert the electromagnetic wave into DC electric power. The Rectennas 41 each have a size of about 2 m×2 m, for example. As illustrated in FIG. 5, a plurality of Rectennas 41 are arranged in an array shape. The reception antenna is constituted by, for example, a dipole antenna, a patch antenna, or the like. The control device 42 has a function of controlling the propelling devices or the driving devices 44 based on information about the voltage value and the current value which is obtained from the Rectennas 41, and information about the position of the electric-power conversion device 4 which is obtained from the positioning devices 43, in order to move the electric-power conversion device 4 to a desired position.

Furthermore, although not illustrated, the control device 42 includes an acceleration sensor, and controls the propelling devices or the driving devices 44 based on information about the attitude which is obtained from the acceleration sensor, in order to stabilize the attitude of the electric-power conversion device 4.

As illustrated in FIG. 5, the positioning devices 43 (for example, GNSS) are installed in such a way as to accurately grasp the position and the orientation of the electric-power conversion device 4. The positioning devices 43 constantly measure the disposition of the electric-power conversion device 4 and share information about the measured position with the control device 42.

The propelling devices or the driving devices 44 are controlled by the control device 42, and propel or drive the electric-power conversion device 4 such that it is disposed at a desired position. The propelling devices or the driving devices 44 are enabled to move and rotate by 360 degrees about the central axis of the electric-power conversion device 4, and are constituted by, for example, screws, water jet propelling devices, wheels, caterpillars, propellers, or the like.

Although not illustrated, as a power source for the propelling devices and the driving devices 44, for example, electric power obtained from the storage batteries 45, a gasoline engine, a diesel engine, or the like can be used. The storage batteries 45 store the electric power received by the Rectennas 41, and supply the stored electric power to the control device 42, the positioning devices 43, and the propelling devices or the driving devices 44. The storage batteries 45 are expected to have a larger capacity and, therefore, may be installed in such a way as to be divided into a plurality of storage batteries 45 as illustrated in FIG. 5.

The electric-power supply devices 46 can be electrically connected to the electricity receiving stations 5 and are configured in such a way as not to be easily detached therefrom due to external disturbances (for example, waves, earthquakes, winds, etc.). As an example of the specific configuration, it is conceived that electrical couplers generally used in railway vehicles are adopted thereas.

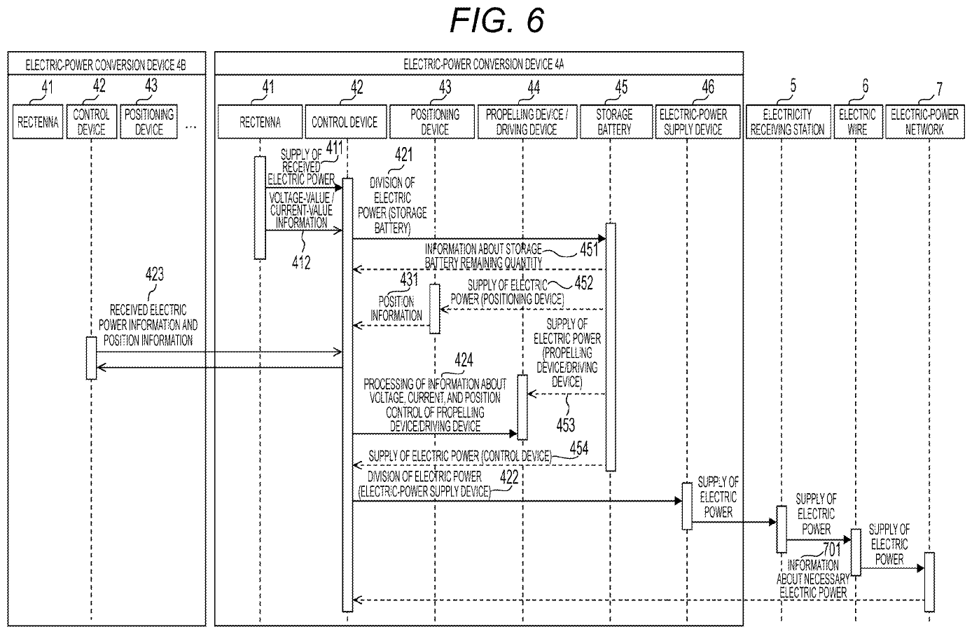

Next, with reference to FIG. 6, there will be described a flow of system processing in the electricity receiving system 3. FIG. 6 is a sequence diagram illustrating flows of information and electric power in the electricity receiving system 3. Incidentally, in this case, there will be representatively exemplified electric-power conversion devices 4A and 4B as a plurality of electric-power conversion devices, and there will be described processing in the electric-power conversion device 4A. The electric-power conversion device 4B is structured and functions similarly to the electric-power conversion device 4A. However, the electric-power conversion device 4B is illustrated, regarding only supply and reception of information between the electric-power conversion devices.

In all the electric-power conversion devices 4 in FIG. 6, the Rectennas 41 supply the received electric power to the control device 42 and, also, transmit information about the voltage value and the current value in the Rectennas 41 to the control device 42, as indicated by 411 and 412.

Next, as indicated by 421 and 422, the control device 42 divides the electric power obtained from the Rectennas 41 and supplies the divided electric power to the storage batteries 45 and the electric-power supply devices 46. At this time, the amounts of electric power distributed therebetween are determined, based on information 451 about the storage-battery remaining quantity which is obtained from the storage batteries 45, and information 701 about necessary electric power required by the electric-power network 7.

Further, as indicated by 452 and 453, the storage batteries 45 supply the stored electric power to the positioning devices 43 and to the propelling devices or the driving devices 44. Further, as indicated by 454, the storage batteries 45 supply electric power to the control device 42, when the electric-power conversion device 4 is disposed outside an electromagnetic-wave irradiation range.

The positioning devices 43 having been supplied with the electric power from the storage batteries 45 constantly transmit information 431 about the measured position to the control device. As indicated by 423, the control device 42 shares the obtained position information 431 and the information about the received electric power which is obtained from the aforementioned voltage value and the aforementioned current value, with the control devices 42 mounted on the other electric-power conversion devices 4. Further, as indicated by 424, based on these pieces of information, the control device 42 controls the propelling devices or the driving devices 44 for disposing the electric-power conversion device 4 at a desired position.

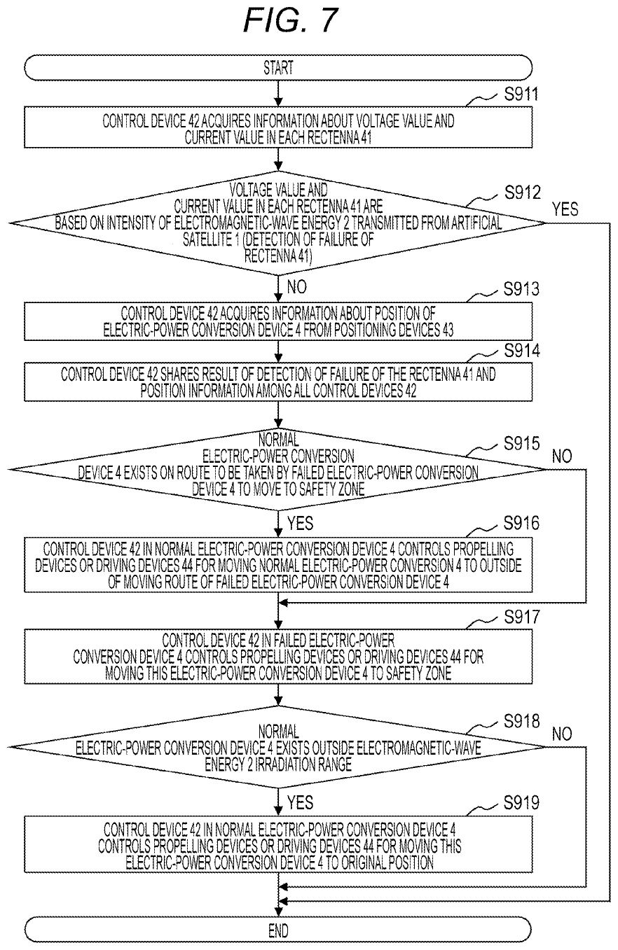

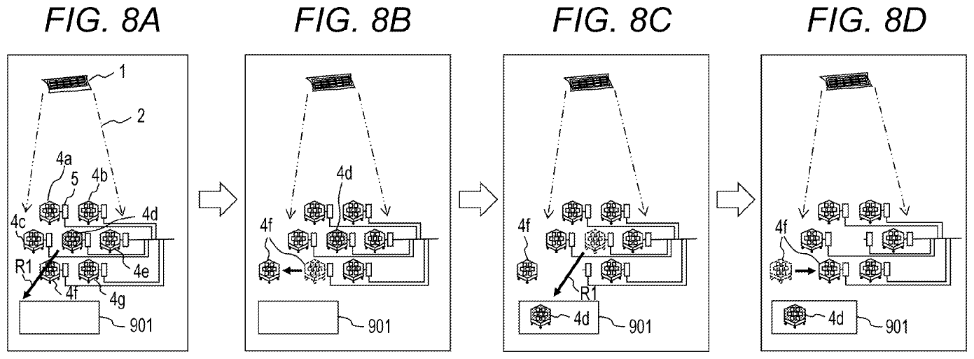

With reference to FIGS. 7 and 8A to 8D, there will be described a flowchart of operations in a case of failure and repair of the electric-power conversion device 4, and an example of operations of the electric-power conversion device 4. Incidentally, in the example of the disposition and the structure of the electric-power conversion devices 4 in FIGS. 8A to 8D, it is assumed that a total of seven electric-power conversion devices 4 (4A to 4g) planarly receive electricity, wherein the total of seven electric-power conversion devices 4 are constituted by two electric-power conversion devices 4, three electric-power conversion devices 4, and two electric-power conversion devices 4 which are arranged from an upper part in the figure.

First, in a processing step S911 in FIG. 7, the control device 42 acquires information about the voltage value and the current value in each Rectenna 41 during receiving electricity. Next, in a processing step S912, the control device 42 compares the acquired information about the voltage value and the current value with an ideal value or a calculated value (FIGS. 3A, 3B) in the intensity distribution of the electromagnetic-wave energy transmitted from the artificial satellite 1. If the current value and the voltage value are not based on the electromagnetic-wave energy intensity distribution, the control device 42 determines that the Rectenna 41 has failed (No). If no failure is detected (Yes), the control device 42 does not perform the subsequent processing.

If the control device 42 determines that the Rectenna 41 has failed, in a processing step S913, the control device 42 acquires information about the position of the electric-power conversion device 4 from the positioning devices 43. Further, as illustrated in a processing step S914, the failure information and the position information about each Rectenna 41 are shared among all the control devices 42. Through this step, as illustrated in FIG. 8A, the control devices 42 grasp the positions of the electric-power conversion device 4 including the failed Rectenna 41 and the normal electric-power conversion devices 4.

In the case of FIG. 8A, it is assumed that an abnormality has occurred in the electric-power conversion device 4d positioned at the center, and the electric-power conversion device 4d has fallen into a state of needing repair. In this case, the repair should be performed in a safety zone 901 outside the electricity receiving area, and the electric-power conversion device 4d should travel and move to the safety zone 901 by itself. However, since the plurality of electric-power conversion devices 4 are disposed at positions as close as possible to each other in the electricity receiving area for high-efficiency electricity reception, a moving route cannot be secured therein.

Next, in a processing step S915 in FIG. 7, the control device 42 determines, from the acquired information, whether a normal electric-power conversion device 4 is disposed on a route to be taken by the failed electric-power conversion device 4d to move to the safety zone 901 (for example, a place where repair of a failure, and maintenance can be performed, outside the electromagnetic-wave irradiation range) illustrated in FIG. 8A.

If a normal electric-power conversion device 4f is disposed on this moving route R1, as illustrated in a processing step S916 in FIG. 7 and FIG. 8B, the control device 42f in the normal electric-power conversion device 4f controls the propelling devices or the driving devices 44f for moving this electric-power conversion device 4f to a place where it will not hinder the movement of the failed electric-power conversion device 4d.

If no obstruction exists on the moving route for the failed electric-power conversion device 4, or when the moving route R1 has been secured through the movement of the normal electric-power conversion device 4f, as illustrated in a processing step S917 in FIG. 7 and FIG. 8C, the control device 42d in the failed electric-power conversion device 4d controls the propelling devices or the driving devices 44d for moving this electric-power conversion device to the safety zone 901.

Thereafter, in a processing step S918 in FIG. 7, it is determined whether the normal electric-power conversion device 4f is disposed outside the electromagnetic-wave energy irradiation range. If the normal electric-power conversion device 4f is disposed outside the electromagnetic-wave energy irradiation range, as illustrated in a processing step S919 in FIG. 7 and FIG. 8D, the control device 42f in the normal electric-power conversion device 4f controls the propelling devices or the driving devices 44f for disposing, again, the electric-power conversion device 4f at the original position. Incidentally, FIG. 8D illustrates an example of temporary operations with a six-device structure having no new electric-power conversion device 4 disposed at the position of the failed electric-power conversion device 4d. However, full operations can be also performed with a seven-device structure having another electric-power conversion device 4 disposed thereafter at this portion.

Through the aforementioned structure and operations, it is possible to realize continuous electricity reception with the electricity receiving system, even during repair of a failure of the Rectennas 41, for example. This provides an advantage of improvement of the electricity receiving efficiency of the entire electricity receiving system.

### Second Example

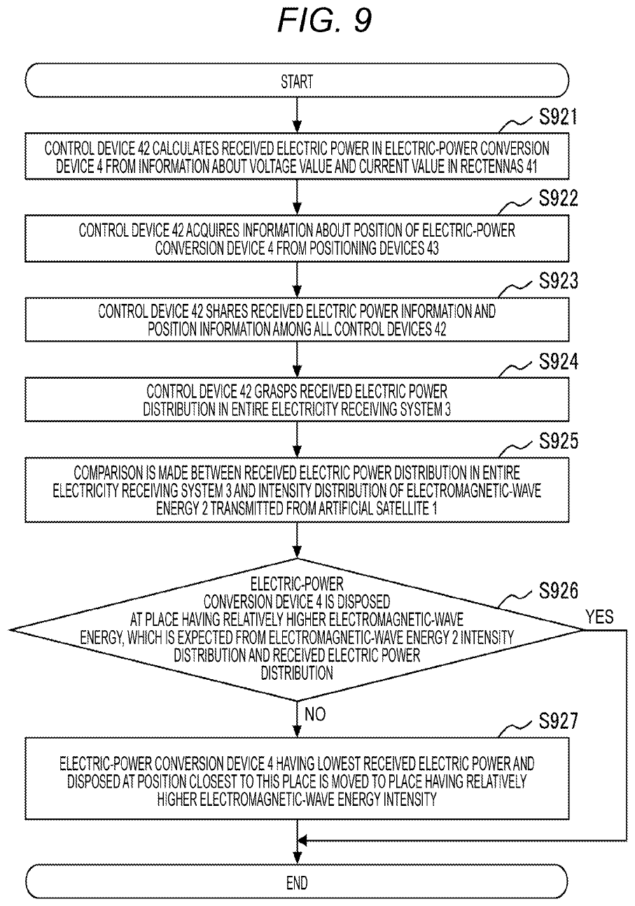

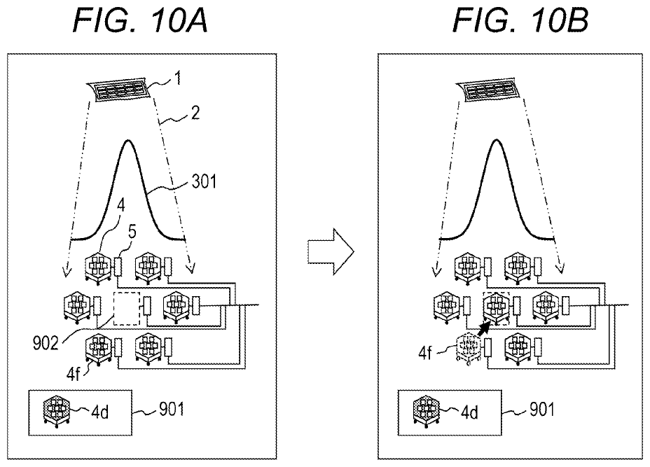

Next, with reference to FIGS. 9 and 10A to 10B, an electricity receiving system 3 according to a second example will be described. The system structure is similar to that of the first example (FIGS. 1 to 6), and will not be described redundantly. FIGS. 9 and 10A to 10B are a flowchart of operations of electric-power conversion devices 4 and schematic diagrams thereof, which particularly illustrate portions different from those of the first example, wherein the structures of unillustrated portions and the flow of system processing are similar to those of the first example.

In the second example, the electric-power conversion devices 4 are enabled to efficiently receive an electromagnetic wave, according to an electromagnetic-wave energy intensity distribution. With reference to FIGS. 9 and 10A to 10B, there will be described a flowchart of operations of the electric-power conversion devices 4, and an example of operations of the electric-power conversion devices 4. Incidentally, the description will be given on the assumption that the disposition in FIG. 8D (no electric-power conversion device 4 is disposed at the center position) is an initial state.

First, in a processing step S921 in FIG. 9, the control device 42 calculates the received electric power (which is expressed as W (the received electric power)=V (the voltage value)×I (the current value), for example) in the electric-power conversion device 4, from information about the voltage value and the current value in each Rectenna 41 during receiving electricity. Further, in a processing step 3922, the control device 42 acquires information about the position of the electric-power conversion device 4 from the positioning devices 43. Further, as illustrated in a processing step S923, the information about the received electric power and the information about the position are shared among all the control devices 42.

Based on these pieces of information, in a processing step 3924, the control device 42 grasps a received electric power distribution 301 in the entire electricity receiving system 3 illustrated in FIG. 10A. Next, in a processing step S925 in FIG. 9, the control device 42 compares the received electric power distribution with an ideal value or a calculated value (FIGS. 3A, 3B) in the electromagnetic-wave energy intensity distribution.

As illustrated in a processing step S926 in FIG. 9 and FIG. 10A, if no electric-power conversion device 4 is disposed at a place 902 where there is a relatively higher electromagnetic-wave energy, in a processing step S927 in FIG. 9, the control device 42 controls the propelling devices or the driving devices 44f in an electric-power conversion device 4 (assumed to be 4f in this case) having a lowest received electric power and disposed near this place, for moving this electric-power conversion device 4 to this place. Furthermore, although not illustrated, in order to efficiently receive the electromagnetic wave 2, the electric-power conversion devices 4 may be changed in formation or shape (to a polygon or a circle, for example).

Through the aforementioned structure and operations, it is possible to realize efficient reception of electromagnetic waves with the electricity receiving system 3, which provides an advantage of improvement of the electricity receiving efficiency of the entire electricity receiving system.

### Third Example

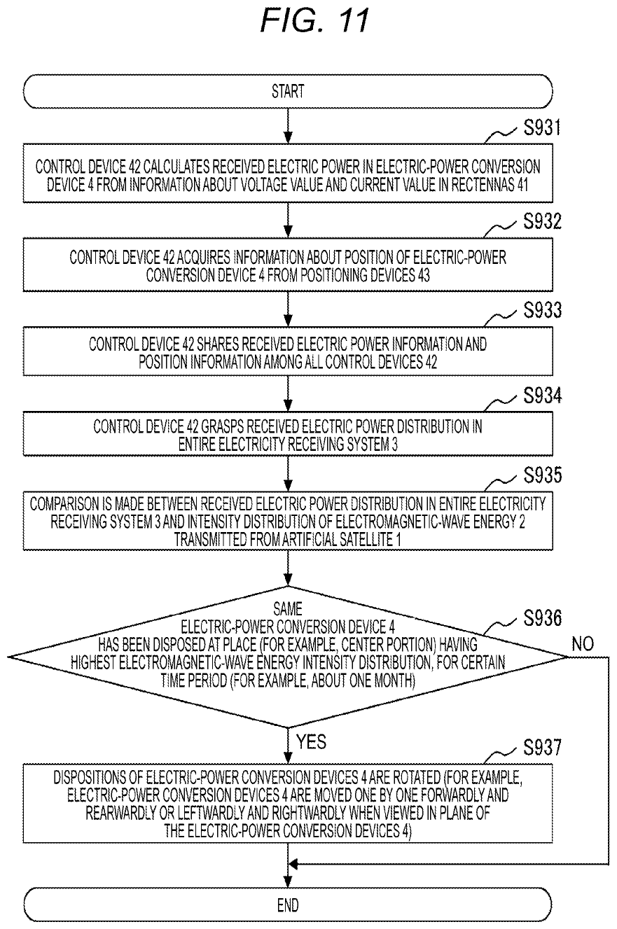

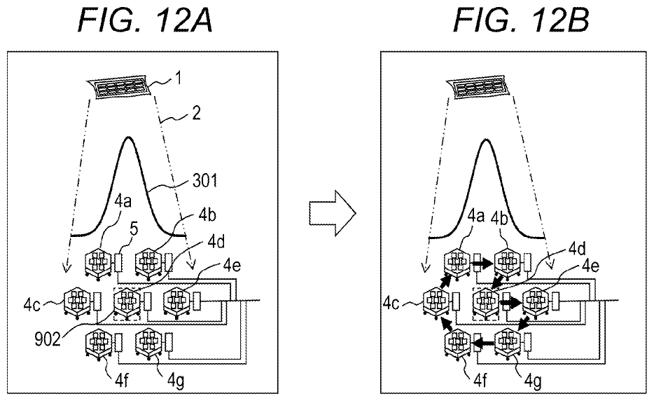

Next, with reference to FIGS. 11 and 12A to 12B, an electricity receiving system according to a third example will be described. The system structure is similar to that of the first example (FIGS. 1 to 6), and will not be described redundantly. FIGS. 11 and 12A to 12B are a flowchart of operations of the electric-power conversion devices 4 and schematic diagrams thereof, which particularly illustrate portions different from those of the first example, wherein the structures of unillustrated portions and the flow of system processing are similar to those of the first example.

In the third example, the electric-power conversion devices 4 are structured such that they can be changed in disposition, in order to equalize the speeds of degradation of the electric-power conversion devices 4 due to the electromagnetic-wave energy intensity distribution. With reference to FIGS. 11 and 12A to 12B, there will be described a flowchart of operations of the electric-power conversion devices 4, and an example of operations of the electric-power conversion devices 4.

First, in processing steps S931, S932, S933, and S934 in FIG. 11, the control device 42 in each electric-power conversion device 4 in an electricity receiving system 3 acquires received-electric-power information and position information about all the electric-power conversion devices 4, and grasps a received electric power distribution 301 in the entire electricity receiving system 3 illustrated in FIG. 12A, similarly to in the operation flowchart according to the second embodiment.

Next, in a processing step S935 in FIG. 11, the control device 42 compares the received electric power distribution with an ideal value or a calculated value (FIGS. 3A, 3B) in the electromagnetic-wave energy intensity distribution. As illustrated in a processing step S936 and FIG. 12A, if an electric-power conversion device 4d disposed at a place 902 (for example, the central portion) having a highest electromagnetic-wave energy intensity has stayed at the same place for a certain time period (for example, about one month), in a processing step S937 in FIG. 11, the control device 42 controls the propelling devices or the driving devices 44 for rotating the disposition of all the electric-power conversion devices 4.

As illustrated in FIG. 12B, for example, the rotation may be performed by moving the electric-power conversion devices 4 one by one forwardly and rearwardly or leftwardly and rightwardly when viewed in a plane. Alternately, based on the received electric power values in the respective electric-power conversion devices 4, the electric-power conversion devices 4 may be divided into two types of electric-power conversion devices 4, which are electric-power conversion devices 4 having higher received electric power and electric-power conversion devices 4 having lower received electric power. Further, the respective types of electric-power conversion devices 4 may be interchanged with each other in disposition, so as to equalize the speeds of degradation of the electric-power conversion devices 4. Furthermore, although not illustrated, an electric-power conversion device 4 disposed at the place 902 having a higher electromagnetic wave energy intensity expected to quickly deteriorate the electric-power conversion device 4 may be changed in size and shape, in order to facilitate rotation and replacement of the electric-power conversion device 4.

Through the aforementioned structure and operations, it is possible to equalize the speeds of degradation of the respective electric-power conversion devices 4, thereby preventing the electric-power conversion devices 4 from being early failed. This provides an advantage of improvement of the electricity receiving efficiency of the entire electricity receiving system.

### Fourth Example

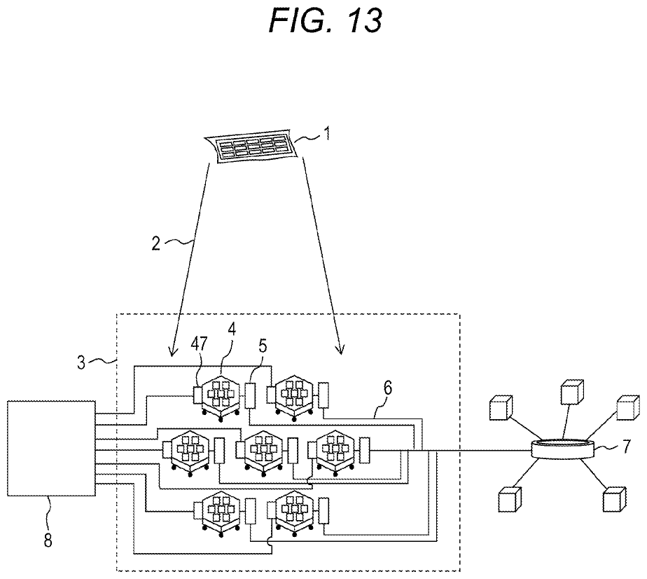

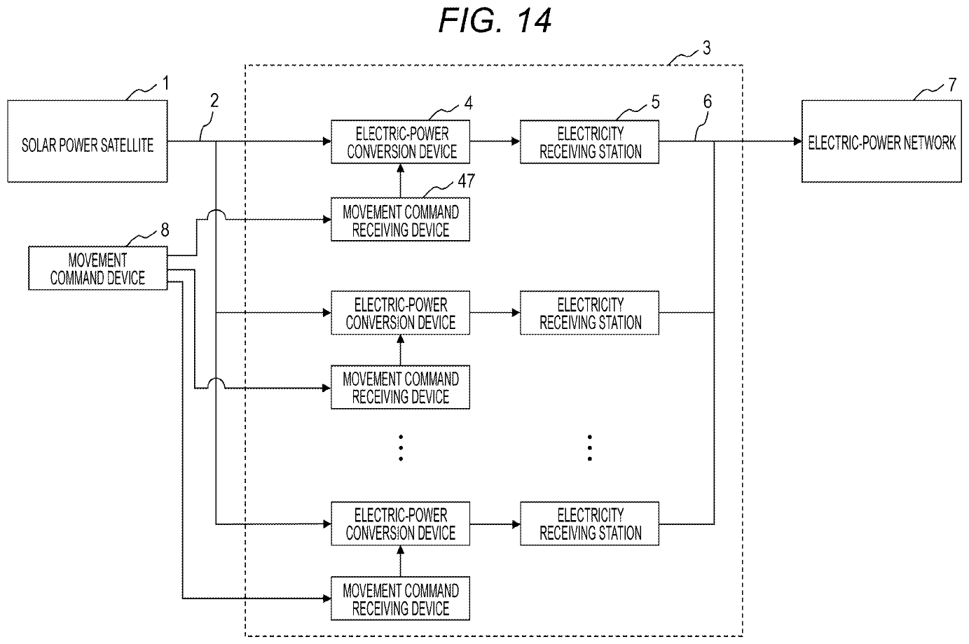

Next, with reference to FIGS. 13 and 14, an electricity receiving system according to a fourth example will be described. The system structure is basically similar to that of the first example (FIGS. 1 to 6), and will not be described redundantly. FIGS. 13 and 14 are schematic views of the space solar power satellite/station/system particularly illustrating portions different from those of the first example, wherein the structures of unillustrated portions and the flow of system processing are similar to those of the first example.

As illustrated in FIGS. 13 and 14, in the fourth embodiment, electric-power conversion devices 4 include a movement command receiving device 47 capable of receiving a movement command inputted from the outside (for example, a movement command device 8). The movement command receiving device 47 transmits the received movement command to the control device 42, and the control device 42 is enabled to control the propelling devices or the driving devices 44 based on position information obtained from the positioning devices 32 and the command transmitted from the movement command receiving device, thereby moving the electric-power conversion device 4.

Through the aforementioned structure and operations, it is possible to move the electric-power conversion devices 4 to desired positions in any situation. For example, in the event of a natural disaster such as a typhoon or tsunami, it is possible to evacuate the electric-power conversion devices 4 to a safety zone (for example, a zone outside a typhoon route in a case of a typhoon, or an offshore zone in a case of a tsunami, or the like) in advance, in order to prevent failures of the electric-power conversion devices 4 due to such natural disasters. This can provide an advantage of improvement of the electricity receiving efficiency of the entire electricity receiving system.

1. An electric-power conversion device for receiving an electromagnetic wave transmitted from space and converting the electromagnetic wave into electric power, the electric-power conversion device comprising:
an electric-power conversion portion for receiving an electromagnetic wave transmitted from space and converting the electromagnetic wave into electric power;
a propelling device or driving device for moving the electric-power conversion device;
a positioning device for determining a position of the electric-power conversion device;
a control device for controlling the propelling device or the driving device based on information about the position and electric power received by the electric-power conversion portion; and
an electric-power supply device for supplying electric power received by the electric-power conversion portion to an electric system.

2. The electric-power conversion device according to claim 1, wherein
the control device controls the propelling device or the driving device based on information about an electromagnetic-wave energy intensity distribution and about the position.

3. The electric-power conversion device according to claim 1, further comprising:
an abnormality detection portion for detecting an abnormality based on information about electric power received by the electric-power conversion portion.

4. The electric-power conversion device according to claim 1, wherein
the control device includes a movement command receiving device for receiving a movement command from outside.

5. An electricity receiving system comprising:
a plurality of the electric-power conversion devices according to claim 1, wherein
the plurality of the electric-power conversion devices are connected to an electric-power system through an electricity receiving station.

6. The electricity receiving system according to claim 5, wherein
among the plurality of electric-power conversion devices, a first electric-power conversion device has a shape different from that of a second electric-power conversion device.

7. The electricity receiving system according to claim 5, further comprising:
a storage battery for storing electric power received by the electric-power conversion portions.

8. A method for controlling an electric-power conversion device for receiving an electromagnetic wave transmitted from space and converting the electromagnetic wave into electric power, the method comprising:
receiving an electromagnetic wave transmitted from space using an electric-power conversion portion;
converting the electromagnetic wave into electric power;
moving the electric-power conversion device using a propelling device or a driving device;
determining a position of the electric-power conversion device using a positioning device;
controlling the propelling device or the driving device based on information about the position and electric power received by the electric-power conversion portion;
supplying electric power received by the electric-power portion to an electric system; and
analyzing information obtained from the electric-power conversion device and the positioning device and changing the position of the electric-power conversion device based on the information.

9. The method for controlling an electric-power conversion device according to claim 8, further comprising:
detecting an abnormality from information about electric power received by the electric-power conversion portion and changing the position of the electric-power conversion device.

10. The method for controlling an electric-power conversion device according to claim 8, further comprising:
analyzing an intensity distribution of the electromagnetic wave and changing the position of the electric-power conversion device based on the analyzed intensity distribution of the electromagnetic wave.

11. The method for controlling an electric-power conversion device according to claim 8, further comprising:
analyzing an intensity distribution of the electromagnetic wave and an electricity receiving time period and changing the position of the electric-power conversion device based on result of the analysis.

12. A method for controlling an electricity receiving system including a plurality of electric-power conversion devices for receiving an electromagnetic wave transmitted from space and converting the electromagnetic wave into electric power, the electric-power conversion devices being connected to an electric power system through an electricity receiving station, the method comprising:
receiving an electromagnetic wave transmitted from space by a plurality of electric power conversion portions each associated with one of said plurality of electric-power conversion devices;
converting, by each said electric power conversion portion, the electromagnetic wave into electric power;
moving each said electric-power conversion device using a propelling device or a driving device;
determining a position of each said electric-power conversion device using a positioning device;
controlling the propelling device or the driving device based on information about the position and electric power received by each said electric-power conversion portion; and
supplying electric power received by each said electric-power conversion portion to an electric system; and
analyzing, by each said electric-power conversion device, information obtained from the electric-power conversion device and the positioning device and changing the position of each said electric-power conversion device based on the information.

13. The method for controlling an electricity receiving system according to claim 12, comprising:
performing rotation for changing the positions of the plurality of the electric-power conversion devices using a control device in each said electric-power conversion device.
